(19) United States
(12) Patent Application Publication
(10) Pub. No.: US 2006/0139358 A1
(43) Pub. Date: Jun. 29, 2006

(54) 3D graphic engine and method of providing graphics in mobile communication terminal

(75) Inventors: Hang Shin Cho, Seoul (KR); Min Jeong Lee, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/320,868

(22) Filed: Dec. 28, 2005

(30) Foreign Application Priority Data
Dec. 29, 2004 (KR) 10-2004-0115123

(51) Int. Cl. G06T 1/20

(52) U.S. Cl. 345/506

(57) ABSTRACT

A graphic engine is provided. The graphic engine includes an object analysis module, a mesh extraction module, a mesh control module, and an algorithm applying module. The object analysis module extracts an array for 3D data and the mesh extracting module has a plurality of meshes and selects a mesh according to the array. The mesh control module controls the size of the mesh according to a bounding box that constitutes an outer contour of the array, and the algorithm applying module applies a shadow algorithm to the size-controlled mesh.

Pursuant to 35 U.S.C. § 119(a), this application claims the benefit of earlier filing date and right of priority to Korean Patent Application No(s). 10-2004-0115123 filed on Dec. 29, 2004, which is hereby incorporated by reference herein in their entirety.

### BACKGROUND OF THE INVENTION

1. Field of the Invention

The present invention relates to a three dimensional (3D) graphic engine and a method of providing graphics in a mobile communication terminal.

2. Description of the Related Art

Recently, mobile communication terminals such as mobile phones, personal digital assistants (PDAs), iBook phones, and smart phones, which can be carried by a user and provides a variety of functions, are widely used.

Such mobile communication terminals provide a variety of functions including a communication function, a wireless Internet function, a diary function, a photographing/reproducing function, and an entertainment function. The entertainment function of providing entertainment contents draws a particular attention of young generation.

Particularly, playing of a game using a mobile communication terminal has advantages that a user can enjoy the game for a short period of time regardless of places and that a user can enjoy the game together with another user through a wireless communication function, so that the playing of a game using a mobile communication terminal is widely used.

However, since engines built in the related art mobile communication terminals do not support a shadow function, reality reduces when the movement of an object contained in a game is expressed.

Currently, under a personal computer (PC) game environment based on a desktop PC or a notebook computer, or under a game environment based on a PDA with a processor of a high specification and a memory device, 3D physical movements of an object contained in a game are smoothly compensated and 3D shadows are substantially expressed to match with a 3D object, so that a splendid image is displayed.

FIG. 1 is a view exemplarily illustrating a shadow effect given to an object contained in a game under the related art PC game environment.

Referring to FIG. 1, a shadow effect a1 is realized almost similarly to a real world according to movements of an object a2 contained in a 3D game.

On the contrary, while the shadow function is realized under an environment based on a general mobile communication terminal such as a cellular phone, a 3D engine, an animation engine, and a physical engine should perform complicated operations on an algorithm such as a space division algorithm, which considerably slows down an operation speed of hardware resources provided to the mobile communication terminal.

That is, even when a high-level shadow operation function is realized on the related art mobile communication terminal, adverse effects such as making performance of a game difficult are generated, which prevents the high-level shadow operation function from being commercially realized.

FIGS. 2 and 3 are views exemplarily illustrating shadow effects b2 and c2 given to objects b1 and c1 contained in a game on the related art mobile communication terminal.

Referring to FIG. 2, though a hexagonal shadow b2 is obliquely displayed at the lower end of an object b1 contained in a game, the hexagonal shadow b2 is seen just as a part of the object b1 and does not give a feeling that the hexagonal shadow b2 is the shadow of the object b1.

Also, referring to FIG. 3, though an elliptical shadow c2 is displayed at the lower center of an object c1 contained in a game, the elliptical shadow c2 always maintains the same shape and the same position on the object c1, which gives unnaturalness to the movements of the object c1.

As a liquid crystal display device (LCD) screen of high image quality is provided and peripheral devices such as external devices (e.g., combination of various keypads and docking stations) using electrical connection interfaces are mounted, games for mobile communication terminals evolve into games having more complicated contents. However, graphic technologies do not support the complicated contents of the game, which is considered as an obstacle to the development of the games for the mobile communication terminals.

### SUMMARY OF THE INVENTION

Accordingly, the present invention is directed to a 3D graphic engine and a method of providing graphics in a mobile communication terminal that substantially obviate one or more problems due to limitations and disadvantages of the related art.

An object of the present invention is to provide a graphic engine for a mobile communication terminal, capable of substantially expressing a shadow so that the shadow may be close to the shape of an image object and allowing the shadow to change a position and a shape thereof as the image object moves while expressing the shadow using only the shape of the image object without casting the shadow of an entire model of the related art 3D image object.

Another object of the present invention is to provide a method of providing 3D graphics for a mobile communication terminal, capable of minimizing operation performances and reducing loads on hardware resources of the mobile communication terminal by setting basic meshes and combining the basic meshes to substantially express a shadow such that the shadow may be close to the shape of an image object.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a 3D graphic engine including: an object analysis module for selecting 3D data for which a shadow is to be displayed according to game progression information and sequentially selecting arrays constituting the 3D data to sequentially extract shadow components that correspond to the arrays; a mesh extraction module having a plurality of circular or polygonal meshes, which are basic models of a 3D shadow, and for extracting a mesh close to the shape of the array from the meshes; a mesh control module for expressing a bounding box that constitutes a minimum outer contour of the arrays and controlling the size of the extracted mesh to match with the bounding box; and an algorithm applying module for applying a shadow algorithm to the 3D data to combine the meshes when meshes that correspond to the arrays are sequentially extracted and controlled.

In another aspect of the present invention, there is provided a method for providing 3D graphics, the method including: selecting 3D data for which a shadow is to be displayed and pointing/selecting a first array constituting the 3D data; expressing a bounding box that constitutes a minimum outer contour of the array and extracting a mesh close to the shape of the array from provided meshes; controlling the size of the extracted mesh to match with the bounding box; sequentially pointing up to a last array and repeatedly performing the selecting, the extracting, and the controlling on a mesh; and applying a shadow algorithm to the 3D data to combine the meshes after a mesh that corresponds to a last array is controlled.

In a further another aspect of the present invention, there is provided a graphic engine including: an object analysis module for extracting an array for 3D data; a mesh extraction module having a plurality of meshes, which are models of the 3D data, and for selecting a mesh according to the array; a mesh control module for controlling the size of the mesh according to a bounding box that constitutes an outer contour of the array; and an algorithm applying module for applying a shadow algorithm to the size-controlled mesh.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view exemplarily illustrating a shadow effect given to an object contained in a game under the related art PC game environment;

FIGS. 2 and 3 are views exemplarily illustrating a shadow effect under a game environment of the related art mobile communication terminal;

FIG. 4 is a view illustrating the construction of a game program where a 3D graphic engine for a mobile communication terminal according to an embodiment of the present invention is realized;

FIG. 5 is a schematic block diagram illustrating elements of a 3D graphic engine for a mobile communication terminal according to an embodiment of the present invention;

FIG. 6 is a view illustrating a screen in which a 3D graphic engine according to an embodiment of the present invention gives a shadow to 3D data;

FIG. 7 is a view illustrating examples of a mesh provided to a graphic engine according to an embodiment of the present invention;

FIG. 8 is a view illustrating a case of applying a method for casting an entire image of the related art 3D data to perform an operation on a shadow to the same movements as those of 3D data shadow-processed by the present invention in FIG. 6; and

FIG. 9 is a flowchart of a method for providing 3D graphics for a mobile communication terminal according to an embodiment of the present invention.

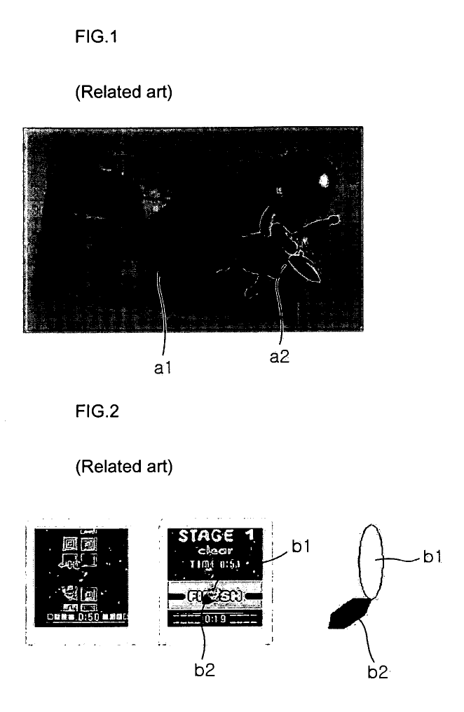

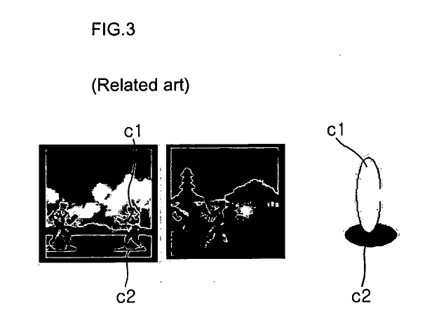

### DETAILED DESCRIPTION OF THE INVENTION

Reference will now be made in detail to the preferred embodiments of the present invention, examples of which are illustrated in the accompanying drawings.

Description will be made on the assumption that a graphic engine of the present invention is realized on a game program of a mobile communication terminal for convenience.

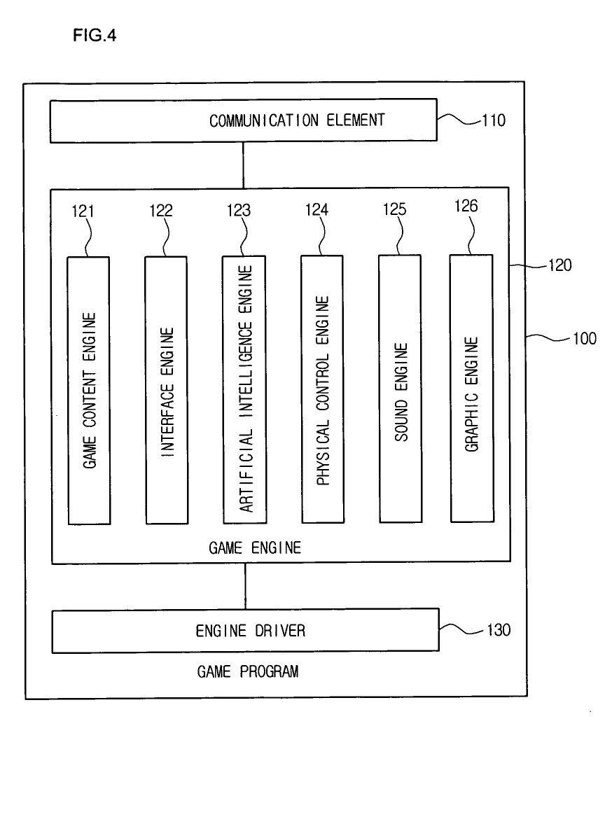

FIG. 4 is a view illustrating the construction of a game program 100 (referred to as a game program according to an embodiment of the present invention hereinafter) where a 3D graphic engine 126 for a mobile communication terminal according to an embodiment of the present invention is realized.

Referring to FIG. 4, the game program according to the embodiment of the present invention includes an engine driver 130, a game engine 120, and a communication element 110. The game engine 120 includes a game content engine 121, an interface engine 122, an artificial intelligence engine 123, a physical control engine 124, a sound engine 125, and a graphic engine 126.

First, when a plurality of mobile communication terminals are connected with one another via on-line to perform a multi-player game, the communication element 110 transmits/receives game progression information to and from other mobile communication terminals in cooperation with a transceiver provided to the mobile communication terminal. The game progression information includes movement information, contact information, event information, and viewpoint information of an image object.

The engine driver 130 allows a hardware and a software of the mobile communication terminal to recognize the game program 100 and provides an interface to allow the game program 100 to be executed and allow data to inputted/outputted.

The game engine 120 is a group of essential program codes and includes sub-engines that perform predetermined functions. The sub-engines will be briefly described below.

The game content engine 121 provides a construction of various screens and scenarios and sets a game object, a movement algorithm of a viewpoint and a progression algorithm of a game in cooperation with the artificial intelligence engine 123.

The interface engine 122 is a program module for analyzing signals from a keypad and a touch screen to apply the signals to a screen. The artificial intelligence engine 123 generates various events for progressing a game depending on operations caused by contact and collision between game objects and the movements of the objects, and weaves the game according to game contents.

The physical control engine 124 simulates the movements, collisions, and repulsions of the game objects and performs an operation on the movements of a viewpoint. The sound engine 125 generates various event sounds for giving a sense of reality to the movements of an image object.

The graphic engine 126 creates data to which the game progression information is applied and finally outputted to the screen. The graphic engine 126 performs a polygon rendering function, a shadow display function, and a light map display function.

The graphic engine 126 loads game object data from a 3D file, performs the polygon rendering to display the same on the screen and expresses animation movements of an object displayed on the screen.

The graphic engine 126 will be described in more detail with reference to FIG. 4.

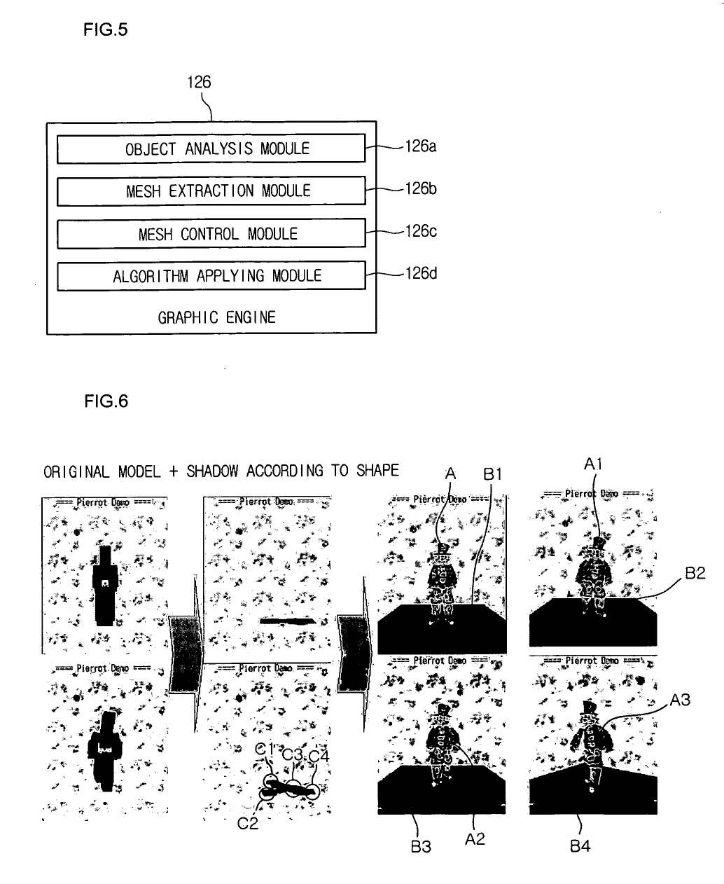

FIG. 5 is a schematic block diagram illustrating elements of the 3D graphic engine 126 for a mobile communication terminal according to an embodiment of the present invention, and FIG. 6 is a view illustrating a screen in which the 3D graphic engine 126 according to an embodiment of the present invention gives a shadow to 3D data.

Referring to FIG. 5, the graphic engine 126 includes an object analysis module 126a, a mesh extraction module 126b, a mesh control module 126c, and an algorithm applying module 126d.

The object analysis module 126a selects 3D data (A) (referred to as a pierrot) for which a shadow is to be displayed using game progression information and sequentially selects arrays constituting the pierrot A. Here, the array is a set of vertexes constituting a 3D data (model) and means a unit that may be divided by the shape and the movements of joints.

The mesh is a concept similar to that of the array and means a portion of real 3D data applied to portions classified according to the array. Therefore, the array means a kind of classifying criterion but the mesh means real data that can be applied in various shapes to one array.

Referring to FIG. 6, the pierrot A may be divided into arrays of a head C1, an arm (not shown), a trunk C3, and a leg C4.

The object analysis module 126a designates the head C1 as a first array of the pierrot using a pointer and separately stores the array of the pierrot and the array of the head.

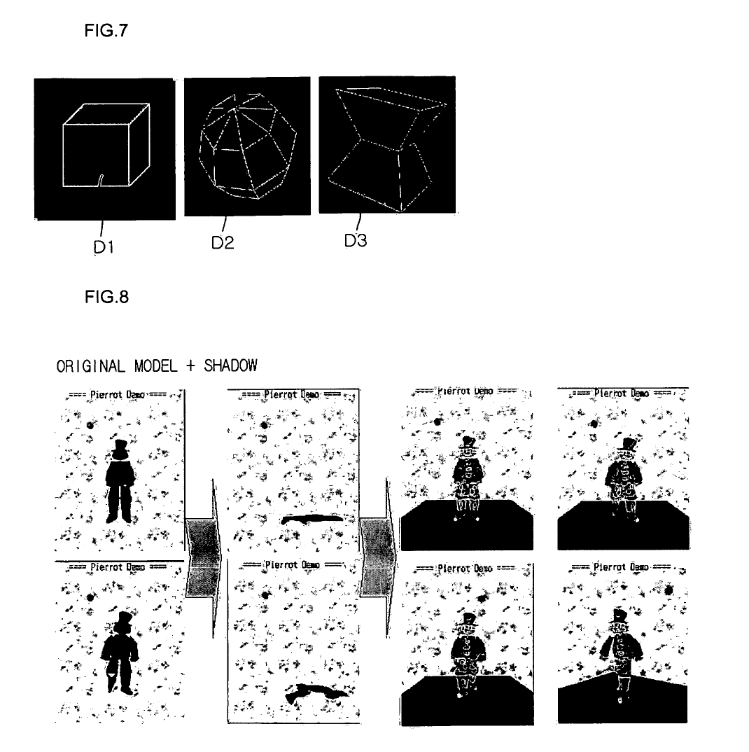

FIG. 7 is a view illustrating examples D1, D2, and D3 of a mesh provided to the graphic engine 126 according to an embodiment of the present invention.

The mesh extraction module 126b defines a plurality of basic meshes, each of meshes being a polyhedron and serving as a model of a 3D shadow. As illustrated in FIG. 7, according to an embodiment of the present invention, the mesh includes a cube type mesh D1, a circular mesh D2, and decahedral ribbon-shaped mesh D3.

The mesh extraction module 126b extracts the circular mesh D2 having a shape most similar to that of the array of the head C1 from the meshes D1, D2, and D3.

The mesh control module 126c extracts maximum values/minimum values of data constituting the arrays from each of x, y, and z axes defining orthogonal coordinate system to combine/generate eight points.

The eight points obtained by the mesh control module 126c mutually form a longest component on a diagonal line, and the mesh control module 126c expresses a hexagonal bounding box constituting a minimum contour of the array using the eight points.

The mesh control module 126c controls the size of the extracted mesh D2 such that the mesh D2 matches with the bounding box, thereby allowing the size of the mesh D2 to be expressed almost similarly to that of a real shadow when the mesh is applied to the pierrot.

Here, when the mesh is the circular mesh or the decahedral mesh, a diameter portion of the mesh has a size that contacts the inner surface of the bounding box as the size of the mesh is controlled such that the mesh matches with the bounding box, so that residual portions except the diameter portion of the mesh is vacant. Therefore, when the size of the mesh is controlled such that the mesh matches with the bounding box, the mesh looks small.

To prevent such a problem, when the mesh is the circular mesh or the decahedral mesh, the mesh control module 126c, the size of the mesh is recontrolled to a size larger a predetermined ratio (i.e., about 1.5 times larger) than the size matched with the bounding box, so that the portions of the mesh lost during the matching are compensated for.

When meshes that correspond to the arrays constituting the pierrot are all extracted and controlled, the algorithm applying module 126d applies a shadow algorithm to the pierrot and combines the meshes to perform an operation on the meshes.

At this point, the algorithm applying module 126d performs a superposition test on the bounding box and processes a screening phenomenon between meshes to display an entire natural shadow.

Referring to FIG. 6, meshes are extracted and size-controlled according to the respective arrays C1, C2, C3, and C4 and expressed at relevant positions through the shadow algorithm. When a shadow process is performed according to one image as described above and the-pierrot moves (i.e., movements A, A1, A2, and A3), respective shadows B1, B2, B3, and B4 are vividly expressed in accordance with the movements A, A1, A2, and A3 of the pierrot.

FIG. 8 is a view exemplarily illustrating a case of applying a method for casting an entire image of the related art 3D data to perform an operation on a shadow to the same movements as those of 3D data shadow-processed by the present invention in FIG. 6.

Comparison of FIG. 8 with FIG. 6 reveals that shadow expression shown in FIG. 6 according to an embodiment of the present invention is processed similarly to a real shadow as much as a shadow expression shown in FIG. 8 where the shadow is expressed most similarly to a real shadow.

According to the graphic engine 126 of the present invention, almost same effect as that of the related art method is achieved with improvement of about 65% in a processing speed.

A method for providing 3D graphics for a mobile communication terminal according to an embodiment of the present invention will now be described.

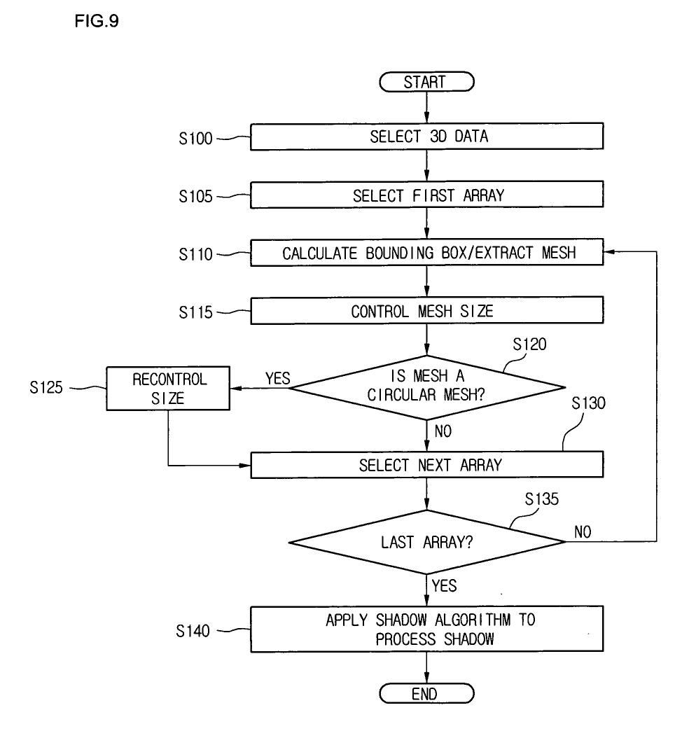

FIG. 9 is a flowchart of a method for providing 3D graphics for a mobile communication terminal according to an embodiment of the present invention.

Referring to FIG. 9, an object analysis module 126a selects 3D data for which a shadow is to be displayed according to game progression information (S100) and points/selects a first array constituting the 3D data (S1O5).

Subsequently, a mesh extraction module 126b expresses a bounding box constituting a minimum outer contour of the array and extracts a mesh having a shape close to the shape of the array from provided meshes (S110).

When the bounding box is expressed, a mesh control module 126c controls the size of the extracted mesh such that the mesh matches with the bounding box (S115).

At this point, when the mesh is a circular mesh or a decahedral mesh (S120), the mesh control module 126c recontrols the size of the mesh as much as a predetermined ratio (S125).

After the mesh control module 126c stores the size-controlled mesh, the object analysis module 126a points and selects the next array (S130).

When the next array is selected, the mesh extraction module 126b extracts a mesh and the mesh control module 126c calculates a bounding box to control the size of the mesh as described above. Such operations are repeated until a last array is processed.

When the object analysis module 126a points the last array and a mesh that corresponds to the last array is extracted/size-controlled (S135), an algorithm applying module 126d applies a shadow algorithm to the 3D data to shadow-process the meshes (S140).

As described above, according to the 3D graphic engine for the mobile communication terminal of the present invention, processing speeds of a processor and a memory are not slowed down even when the shape and the movement of the shadow are substantially expressed for original 3D data, and natural movements of the 3D data and the shadow thereof can be expressed. Therefore, when enjoying a game on a mobile communication terminal or using image contents such as an avatar, a user can more vividly enjoy/use the game or the image contents.

Also, according to the present invention, hardware resources of the related art mobile communication terminal are used as they are, and a shadow processing function, which is one of portions that require most frequent operation processes without a separate additional device, is realized using a software. Therefore, the same effect as that of high-priced apparatus is achieved while achieving improvement in productivity and reduction in manufacturing costs.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A 3D (3 dimensional) graphic engine comprising:
an object analysis module for selecting 3D data for which a shadow is to be displayed according to game progression information and sequentially selecting arrays constituting the 3D data to sequentially extract shadow components that correspond to the arrays;
a mesh extraction module having a plurality of circular or polygonal meshes, which are basic models of a 3D shadow, and extracting a mesh close to the shape of the array from the meshes;
a mesh control module for expressing a bounding box that constitutes a minimum outer contour of the arrays and controlling the size of the extracted mesh to match with the bounding box; and
an algorithm applying module for applying a shadow algorithm to the 3D data to combine the meshes when meshes that correspond to the arrays are sequentially extracted and controlled.

2. The 3D graphic engine according to claim 1, wherein the object analysis module designates a first array of the 3D data using a pointer, and when the mesh extraction module and the mesh control module operate on the first array, the object analysis module sequentially moves the point to allow the mesh extraction module and the mesh control module to repeatedly operate on up to a last array.

3. The 3D graphic engine according to claim 1, wherein the mesh control module extracts a maximum value and a minimum value of data that constitute the array from each of axes that form a space of an orthogonal coordinate system to combine eight points and the mesh control module expresses a hexahedral bounding box constituting a minimum outer contour of the array by including the eight points.

4. The 3D graphic engine according to claim 1, wherein the mesh comprises at least one of a hexahedral mesh, a circular mesh, a decahedral ribbon-shaped mesh, and a tetrahedral cube-shaped mesh.

5. The 3D graphic engine according to claim 4, wherein the mesh control module recontrols the size of the mesh a predetermined ratio such that the mesh has a size larger than the size matched with the bounding box when the mesh is the circular mesh or the decahedral ribbon-shaped mesh.

6. The 3D graphic engine according to claim 1, wherein the algorithm applying module performs a superposition test on the bounding box and processes a screening phenomenon between the meshes to display an entire shadow when applying the shadow algorithm to the 3D data.

7. A method for providing 3D graphics, the method comprising:
selecting 3D data for which a shadow is to be displayed and pointing/selecting a first array constituting the 3D data;
expressing a bounding box that constitutes a minimum outer contour of the array and extracting a mesh close to the shape of the array from provided meshes;
controlling the size of the extracted mesh to match with the bounding box;
sequentially pointing up to a last array and repeatedly performing the selecting, the extracting, and the controlling on a mesh; and
applying a shadow algorithm to the 3D data to combine the meshes after a mesh that corresponds to a last array is controlled.

8. The method according to claim 7, further comprising: recontrolling the size of the mesh a predetermined ratio such that the mesh has a size larger than the size matched with the bounding box when the mesh is a circular mesh or a decahedral ribbon-shaped mesh.

9. A graphic engine comprising:
an object analysis module for extracting an array for 3D data;
a mesh extraction module having a plurality of meshes, which are models of the 3D data, and for selecting a mesh according to the array;
a mesh control module for controlling the size of the mesh according to a bounding box that constitutes an outer contour of the array; and
an algorithm applying module for applying a shadow algorithm to the size-controlled mesh.

10. The graphic engine according to claim 9, wherein the object analysis module designates a first array of the 3D data using a pointer, and when the mesh extraction module and the mesh control module operate on the first array, the object analysis module sequentially moves the point to allow the mesh extraction module and the mesh control module to repeatedly operate on up to a last array.

11. The graphic engine according to claim 9, wherein the mesh control module extracts a maximum value and a minimum value of data that constitute the array from each of axes that form a space of an orthogonal coordinate system to combine eight points and the mesh control module expresses a hexahedral bounding box constituting a minimum outer contour of the array by including the eight points.

12. The graphic engine according to claim 9, wherein the mesh comprises at least one of a hexahedral mesh, a circular mesh, a decahedral ribbon-shaped mesh, and a tetrahedral cube-shaped mesh.

13. The graphic engine according to claim 9, wherein the mesh control module recontrols the size of the mesh a predetermined ratio such that the mesh has a size larger than the size matched with the bounding box when the mesh is a circular mesh or a decahedral ribbon-shaped mesh.

14. The graphic engine according to claim 9, wherein the algorithm applying module performs a superposition test on the bounding box and processes a screening phenomenon between the meshes to display an entire shadow when applying the shadow algorithm to the 3D data.
